(19) United States
(12) Patent Application Publication
(10) Pub. No.: US 2013/0306482 A1
(43) Pub. Date: Nov. 21, 2013

(54) IONIC SPECIES REMOVAL SYSTEM

(71) Applicants: Hai Yang, Shanghai (CN); John Harold Barber, Ontario (CA); Rihua Xiong, Shanghai (CN); Wei Cai, Shanghai (CN); Chang Wei, Niskayuna, NY (US)

(72) Inventors: Hai Yang, Shanghai (CN); John Harold Barber, Ontario (CA); Rihua Xiong, Shanghai (CN); Wei Cai, Shanghai (CN); Chang Wei, Niskayuna, NY (US)

(21) Appl. No.: 13/980,939

(22) PCT Filed: Jan. 3, 2012
(86) PCT No.: PCT/US12/20051

§ 371 Date: Jul. 22, 2013

(30) Foreign Application Priority Data
Jan. 25, 2011 (CN) 201110026590.1

(51) Int. Cl. C02F 1/469

(52) U.S. Cl. CPC C02F 1/4693
USPC 204/632

(57) ABSTRACT

The present invention relates to an ionic species removal system comprising one or more electrode stack(s), each electrode stack including two electrodes and cation exchange membranes and anion exchange membranes alternately arranged between the two electrodes, wherein at least one electrode of at least one of the electrode stack(s) is an electrode coated with an ion exchange coating. The ionic species removal system mitigates the scaling risk by employing an electrode coated with an ion exchange coating.

### BACKGROUND

The present invention relates generally to ionic species removal systems, and more particularly to electrodialysis and/or electrodialysis reversal systems that utilize an electrode coated with an ion exchange coating.

The use of electrodialysis (ED) and electrodialysis reversal (EDR) systems to separate ionic species in solutions is known. The ED and EDR systems generally involve the use of Faraday reactions at terminal electrode to generate the electric field across the membranes and spacers that make-up the system. Faraday reactions are the reactions that take place between electrodes and electrolytes in electrolytic cells. A Faraday reaction is an electron transfer process. An electron transfer reaction can consist of either a reduction reaction or an oxidation reaction that happen at either of the electrodes. A chemical species is called reduced when it gains electrons through a reduction reaction, and is oxidized when it loses electrons through an oxidation reaction. However, disadvantages of known ED and EDR systems which utilize electrodes that conduct Faraday reactions include the complexity of the system designs, a low electrode life due to the corrosion stemming from the Faraday reactions and metal precipitation at the hydroxide producing cathode. Additionally, the gas evolution, oxygen at the anode and hydrogen at the cathode, requires the need for degassifiers, increasing the complexity and cost of the ED and/or EDR systems.

In order to solve the above problems, US2008057398A1 proposes an ionic species removal system, comprising: a power supply; a pump for transporting a liquid through the system; and a plurality of porous electrodes, each comprising an electrically conductive porous portion. By contacting the porous portion with an ionic electrolyte, the apparent capacitance of the electrodes can be very high when charged. When the porous electrode is charged as a negative electrode, cations in the electrolyte are attracted to the surface of the porous electrode under electrostatic force. A double layer capacitor may be formed by this means at the electrode/electrolyte interphase. That is, the ionic species removal system utilizes a non-Faraday process which is an electrostatic process. The electrostatic nature of the non-Faraday process means no formation of gases, and therefore degassifiers are not needed in the system.

However, the present inventors discovered that the ionic species removal system in US2008057398A1 possesses a risk of scaling. After the porous electrode adsorbs a certain number of ions by applying voltage, the system will enter an idle stage. At this time, some of the adsorbed ions will be automatically desorbed into the electrolyte due to self discharging. During the desorbing process, reversing the applied voltage after the idle stage, water electrolysis can occur in the case where the adsorbing time and the desorbing time are the same, and the ions in the porous electrode are not sufficient to accomplish the desorbing process due to the above mentioned self discharging process. When the electrolysis occurs, a number of Off ions are generated in the negatively charged electrode. When cations which easily precipitate, such as Ca²⁺, Mg²⁺, and Fe³⁺ are present in a solution adjacent to the negative electrode, precipitates will be generated on the surface of the electrode and in the solution, resulting in scaling. For example,

2H₂O+2e−→2OH−+H₂

CO₂+2OH⁻+Ca²⁺→CaCO₃+H₂O

Therefore, there is still a need for improvement in the ionic species removal system.

### BRIEF DESCRIPTION

The present invention relates to an ionic species removal system comprising one or more electrode stack(s), each electrode stack including two electrodes and cation exchange membranes and anion exchange membranes alternately arranged between the two electrodes, wherein at least one electrode of at least one of the electrode stack(s) is an electrode coated with an ion exchange coating.

These and other advantages and features will be more readily understood from the following detailed description of preferred embodiments of the invention that is provided in connection with the accompanying drawings.

### BRIEF DESCRIPTION OF THE DRAWINGS

FIG. 1 is a schematic view of an electrode stack according to one embodiment of the present invention, with anion and cation ion exchange coated electrodes.

FIG. 2 is a schematic view of an electrode stack according to another embodiment of the present invention, with only anion ion exchange coated electrodes.

FIG. 3 is a schematic view of an electrode stack according to yet another embodiment of the present invention, with only cation ion exchange coated electrodes.

### DETAILED DESCRIPTION

In the ionic species removal system of the present invention, at least one electrode of at least one of the electrode stack(s) is an electrode coated with an ion exchange coating. By employing such an electrode coated with an ion exchange coating, the scaling risk of the ionic species removal system can be mitigated. Since the ion exchange coating contains many ionically charged sites which have counter ions from solution, when the amount of ions in the electrode are not enough to accomplish the desorbing process as described above, excess charge on the electrode is buffered by the ions in the ion exchange coating being released to help accomplishing the desorbing process. In this way, the scaling risk in the ionic species removal system will be mitigated significantly.

The ionic species removal system of the present invention may be an electrodialysis (ED) system that includes a feed tank, a feed pump, a filter, and one or more electrode stack(s). Alternatively, the ionic species removal system of the present invention may be an electrodialysis reversal (EDR) system that includes a pair of feed pumps, a pair of variable frequency drivers, a pair of reversal valves, and one or more electrode stack(s). Designs of the electrode stack(s) in the ionic species removal system of the present invention will be described in detail below. As to other members in the ionic species removal system of the present invention, reference can be made to US2008057398A1, the entire disclosure of which is incorporated herein by reference.

In the present invention, at least one electrode of at least one of the electrode stack(s) is an electrode coated with an ion exchange coating. Preferably, both of two electrodes of at least one of the electrode stack(s) are electrodes coated with an ion exchange coating.

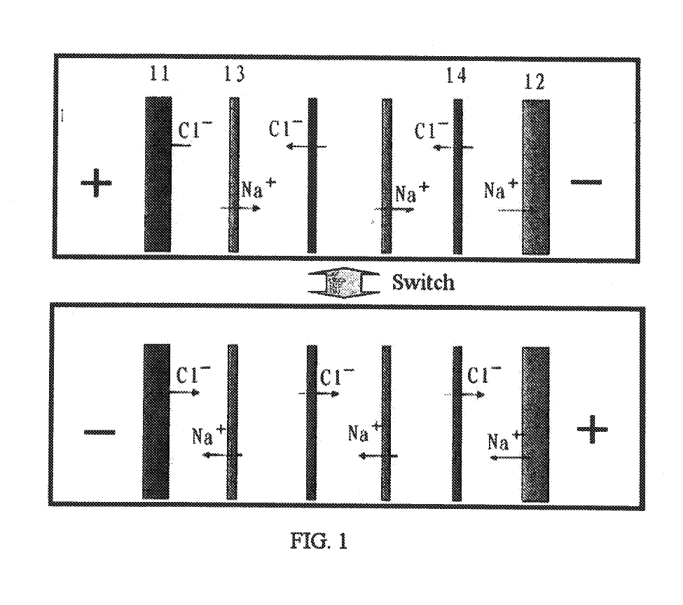

In one embodiment, one of two electrodes is an electrode coated with an anion exchange coating, and the other is an electrode coated with a cation exchange coating. A cation exchange membrane is adjacent to said electrode coated with an anion exchange coating, and an anion exchange membrane is adjacent to said electrode coated with a cation exchange coating. By referring to FIG. 1, an electrode coated with an anion exchange coating 11 is adjacent to a cation exchange membrane 13, and an electrode coated with a cation exchange coating 12 is adjacent to an anion exchange membrane 14. When voltage is applied as shown in the upper part of FIG. 1, the electrode coated with an anion exchange coating 11 as a positive electrode and the electrode coated with a cation exchange coating 12 as a negative electrode perform adsorbing processes, wherein the positive electrode adsorbs anions, and the negative electrode adsorbs cations. Both the electrode coated with an anion exchange coating 11 and the electrode coated with a cation exchange coating 12 contact dilute streams, and there is no scaling issue. After a certain number of ions are adsorbed, the idle stage is entered. At this time, some of the adsorbed ions are desorbed automatically due to self discharging. Subsequently, the voltage is reversed to perform desorbing processes, as shown in the lower part of FIG. 1. The electrode coated with an anion exchange coating 11 as a negative electrode contacts with a concentrate stream, and the scaling risk exists due to insufficient anions caused by the above self discharging. At this time, anions in the anion exchange coating can be released to perform the desorbing process, thus avoiding water electrolysis and thereby mitigating the scaling risk.

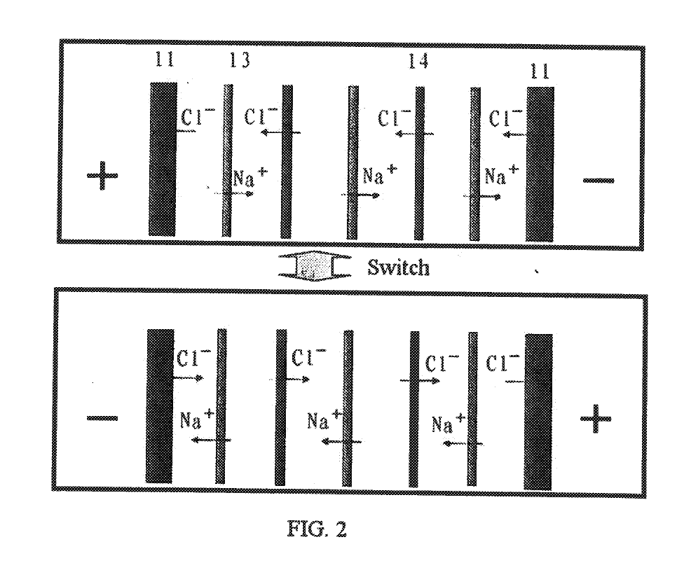

In another embodiment, both of the two electrodes are electrodes coated with an anion exchange coating. Cation exchange membranes are adjacent to said electrodes coated with an anion exchange coating. By referring to FIG. 2, electrodes coated with an anion exchange coating 11 are adjacent to cation exchange membranes 13. In the embodiment, the ion in the anion exchange coating can similarly be released to help accomplishing the desorbing process, thereby mitigating the scaling risk. In addition, when voltage is applied as shown in the upper part of FIG. 2, a negative electrode contacts a concentrate stream, and a positive electrode contacts a dilute stream. Even if electrolysis occurs due to thermodynamic or kinetic causes or operational error, the scaling takes place at the negative electrode contacting the concentrate stream, while in the mean time, the positive electrode contacting the dilute stream generates an acid solution which can self clean the scaling precipitated. The amount of water electrolysis which may occur in this embodiment under these abnormal circumstances is minor compared to prior art electrodes, e.g Pt coated Ti or graphite, where water electrolysis always occurs, and significant amounts of scale are produced if counter measures such as acid injection are not employed. After the voltage is reversed as shown in the lower part of FIG. 2, since the electrode in which the scaling take places becomes the positive electrode, and thus contacts the dilute stream and generates the acid solution which self cleans the scaling. In this way, the scaling risk can be further mitigated.

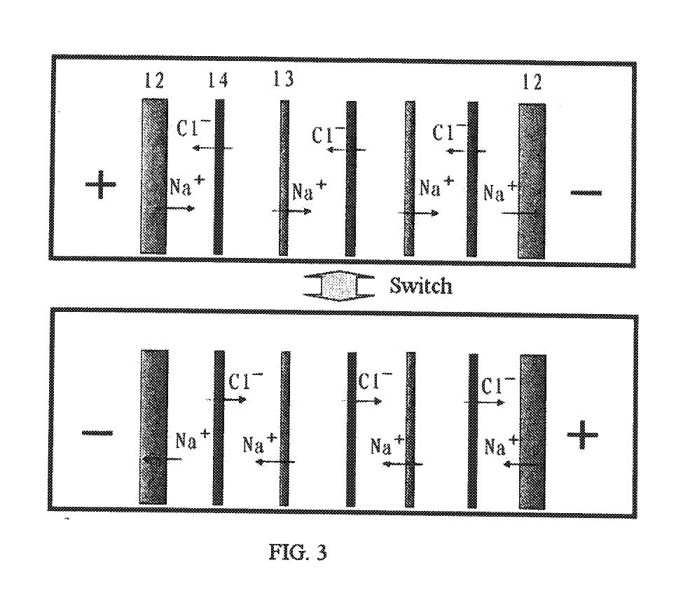

In yet another embodiment, both of two electrodes are electrodes coated with a cation exchange coating. Anion exchange membranes are adjacent to said electrodes coated with a cation exchange coating. By referring to FIG. 3, electrodes coated with a cation exchange coating 12 are adjacent to anion exchange membranes 14. In the embodiment, the ion in the cation exchange coating can similarly be released to help accomplishing the desorbing process, thereby mitigating the scaling risk. In addition, when voltage is applied as shown in the upper part of FIG. 3, a positive electrode contacts a concentrate stream, and a negative electrode contacts a dilute stream. After the voltage is reversed as shown in the lower part of FIG. 3, the positive electrode still contacts the concentrate stream, and the negative electrode still contact the dilute stream. That is, under this circumstance, the positive electrode always contacts the concentrate stream, and the negative electrode always contacts the dilute stream. Therefore, it is less possible for the scaling to precipitate on the electrode. That is, the scaling risk is further mitigated.

Next, the electrode coated with an ion exchange coating will be described. the electrode coated with an ion exchange coating comprises an electrode matrix and an ion exchange coating.

The electrode matrix comprises a porous material. The porous material may be any conductive material with a high surface area. Non-limiting examples of the porous material include activated carbon, carbon nanotubes, graphite, carbon fiber, carbon cloth, carbon aerogel, metallic powders, for example nickel, metal oxides, for example ruthenium oxide, conductive polymers, and any combination thereof. The electrode matrix may further include a substrate. The substrate may be formed of any suitable metallic structure, such as, for example, a plate, a mesh, a foil, or a sheet. Furthermore, the substrate may be formed of suitable conductive material, such as, for example, stainless steel, graphite, titanium, platinum, iridium, rhodium, or conductive plastic. The electrode matrix may be porous and conductive enough so that the substrate is not needed. Specifically, as to the electrode matrix, reference may be made to US2008057398A1.

The ion exchange coating comprises an ion exchange material well known in the field. The ion exchange material includes an anion exchange material and a cation exchange material. One or more conducting polymer may be employed as the anion exchange material. Non-limiting examples of such conducting polymers may include polyaniline, polypyrrole, polythiophene, or combinations thereof. One or more ionic conducting polymer may be employed as the ion exchange material. The ionic conducting polymer may be a polymerization product of one or more ionic monomers. The cation exchange material may be a polymerization product of a cationic monomer. Non-limiting examples of the cationic monomer include sulfonic acid or its salts, carboxylic acid or its salts, or combinations thereof, for example, 2-acrylamido-2-methylpropanesulfonic acid, 4-styrenesulfonic acid sodium salt and the like. The anion exchange material may be a polymerization product of an anionic monomer. Non-limiting examples of the anionic monomer include primary amines, secondary amines, tertiary amines, quarternary ammoniums, imidazoliums, guanidiniums, pyridiniums, or combinations thereof, for example, 2-(dimethylamino)ethyl methacryalte, 4-vinylbenzyl trimethylammonium chloride and the like.

In one embodiment, the ion exchange coating is coated on the surface of the electrode matrix. It can be carried out by known methods in the field. For example, the method includes, but is not limited to, a method of mixing the ion exchange material powder with a solvent to form a suspension, adding a binder thereto, agitating the resultant homogeneously, coating the homogeneous mixture on the surface of the electrode matrix, and drying.

In one embodiment, when the electrode matrix comprises the porous material, the ion exchange coating is coated inside porous portions of the porous material. It can be carried out by known methods in the field. For example, the method includes, but is not limited to, a method of forming a mixture of the ionic monomer, a cross-linker and a proper initiator, dispersing the mixture in the porous portions of the porous material by, for example, dipping, and polymerizing the ionic monomer in the porous portions to form the ion exchange coating.

In one embodiment, the ion exchange coating can be coated inside the porous portions of the porous material and on the surface of the electrode matrix.

The ionic species removal system is applicable to a general process in which ionic species are removed out of fluid, such as water purification, waste water treatment, mineral removal, etc. Applicable industries include but are not limited to water and processes, pharmaceuticals, and food and beverage industries.

The present invention is further described by reference to examples below. However, the examples are only exemplary, and not limiting of the present invention.

### EXAMPLE 1

In this Example, two identical electrode stacks were assembled in an EDR system to test on synthetic brackish feed water. Each electrode stack had 80 pairs of anion exchange membranes (CR67, produced by GE Corp.) and cation exchange membranes (AR204, produced by GE Corp.) In each electrode stack, one electrode was coated with an anion exchange material, immediately next to which was a flow space followed by the cation exchange memberane, and the other electrode was coated with a cation exchange material, immediately next to which was a flow space followed by the anion exchange membrane. The effective area of each of the membranes and the electrodes was 400 cm².

The electrode coated with an anion exchange material was prepared as follows. A carbon sheet of 16 cm×32 cm (produced by Shandong Haite Corp., having a thickness of 0.65 mm) was pressed onto a current collector of titanium mesh (produced by Shanghai Yuqing Material Science and Technology Co. Ltd., having a thickness of 0.35 mm) by using a platen press with a pressing pressure of 100 kgf/cm², to form a carbon electrode of capacitor. 17.25 g of 2-(dimethylamino)ethyl methacryalte, 14.2 g of glycidyl methacrylate, and 43.6 g of methanesulfonic acid were mixed in a vessel placed in a ice bath. Then, the vessel was disposed on a heating device to raise the temperature to 50° C. slowly with stirring, and was kept at this temperature and stood for 3 hours. After the temperature was cooled down to room temperature (25), 0.75 g of 2,2′-azobis[2-methylpropionamidine] dihydrochloride as an initiator was added and stirred until it was completely dissolved. The obtained solution was coated onto the above carbon capacitor electrode, then heated to 85° C., and kept at this temperature for 1 hour until the polymerization reaction was complete. Therefore, a smooth film was formed on the carbon electrode. As such, the electrode coated with an anion exchange material was formed.

The electrode coated with a cation exchange material was prepared as follows. Firstly, the carbon electrode of capacitor was formed as described above. 10 g of phenol, 32.4 g of N-hydroxymethylacrylamide, and 40 g of 2-acrylamido-2-methylpropanesulfonic acid were dissolved in 60 g of deionized water to form a solution of No. 1. Then, 1.5 g of 2,2′-azobis[2-methylpropionamidine]dihydrochloride as an initiator was dissolved in 6.3 g of deionized water to form a solution of No. 2. Finally, the solutions of Nos. 1 and 2 were mixed together with stirring until thorough mixing. The obtained solution was coated on the above carbon capacitor electrode, then heated to 85° C., and kept at this temperature for 1 hour until the polymerization reaction was complete. Therefore, a smooth film was formed on the carbon electrode. As such, the electrode coated with a cation exchange material was formed.

The above two electrode stacks were electrically connected in series in the EDR system so that only one dc power supply was required during the testing. Hydraulically, the two electrode stacks were also connected in series with the water from the first stack flowing into the second stack.

The synthetic brackish feed water had a Total Dissolved Solids (TDS) of about 3,000 ppm and was made according to the recipe shown in Table 1. Sulfuric acid was injected in the feed water to lower its pH down to about 6. The conductivity of the feed water after acid injection was around 4,600 μS/cm.

TABLE 1

| Salt | CaCl₂ | MgSO₄ | NaHCO₃ | Total |
|---|---|---|---|---|
| Concentration | 513 | 1146 | 1341 | 3000 |
| (ppm) | | | | |

The EDR system was operated with a DC power supply (LANDdt, produced by Wuhan Jinnuo Electron Co. Ltd.) set at a voltage of 85V and the flow and the power supply polarity were reversed every 1000 seconds. The current for both electrode stacks was about 1.7 A. The conductivity of the product stream was about 1,000 μS/cm.

The experiment ran continuously for about 50 hours with stable stack current and product quality.

### EXAMPLE 2

In this example, one electrode stack was assembled in an EDR system to test on synthetic brackish feed water. The electrode stack has two electrodes coated with an anion exchange coating, five pieces of cation ion exchange membranes, and four anion ion exchange membranes, wherein the electrode was adjacent to one flow space followed by one cation exchange membrane. The electrode coated with an anion exchange coating, the cation exchange membrane, and the anion exchange membrane were the same as those in the Example 1. The effective area of each of the membranes and the electrodes was 400 cm².

The synthetic brackish feed water was the same as that in the Example 1. Sulfuric acid was injected in the feed water to lower its pH down to about 6. The conductivity of the feed water after acid injection was around 4,600 μS/cm.

The EDR system was operated with a DC power supply set at a voltage of 8V and the flow and the power supply polarity were reversed every 1000 seconds. The current for the electrode stack was about 4-3.5 A. The conductivity of the product stream was about 2,400 μS/cm.

The experiment ran continuously for about 400 hours with stable stack current, product quality and no scaling observed.

### EXAMPLE 3

In this example, two electrode stacks were tested to determine if hardness scale formation occurred on the EDR electrodes. The first electrode stack (referred to as No. 1 electrode stack hereinafter) was the same as that in Example 2, except that no anion exchange material was formed on or in the electrode. The second electrode stack (referred to as No. 2 electrode stack hereinafter) was the same as that in Example 2.

The synthetic brackish water as a feed water was the same as that in the Example 1. However, sodium hydroxide was added into the feed water to increase the pH to about 9.5. After sodium hydroxide was added, the conductivity of the feed water was around 4,100 μS/cm.

The EDR systems including the two electrode stacks were operated with a DC power supply (LANDdt, produced by Wuhan Jinnuo Electron Co. Ltd.), respectively, and the flow of water and the power supply polarity were reversed every 1000 seconds. Voltages were adjusted to ensure that the conductivities of the product streams of the two electrode stacks were the same, both of which were 3,100 μS/cm.

The EDR systems including the two electrode stacks were continuously operated for 7 cycles, i.e., 7,000 seconds. Then the electrode stacks were opened to observe the scaling state of the electrodes. Regarding the No. 1 electrode stack, white precipitate could be clearly seen in the electrodes. The precipitate was reacted with hydrochloric acid solution to produce a number of gas bubbles, and therefore could be identified as calcium carbonate. Regarding the No. 2 electrode stack, there was substantially no obvious scaling on the surface of the electrodes. Therefore, this example demonstrated that the electrode coated with an ion exchange coating had a lower scaling risk than the electrode without an ion exchange coating.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention.

What is claimed is:

1. An ionic species removal system comprising one or more electrode stack(s), each electrode stack including two electrodes and cation exchange membranes and anion exchange membranes alternately arranged between the two electrodes, wherein at least one electrode of at least one of the electrode stack(s) is an electrode coated with an ion exchange coating.

2. The system of claim 1, wherein said system is an electrodialysis system or an electrodialysis reversal system.

3. The system of claim 1, wherein both of the two electrodes of at least one of the electrode stack(s) are electrodes coated with an ion exchange coating.

4. The system of claim 3, wherein one of the two electrodes of at least one of the electrode stack(s) is an electrode coated with an anion exchange coating, and the other is an electrode coated with a cation exchange coating.

5. The system of claim 4, wherein a cation exchange membrane is adjacent to said electrode coated with an anion exchange coating, and an anion exchange membrane is adjacent to said electrode coated with a cation exchange coating.

6. The system of claim 3, wherein both of the two electrodes of at least one of the electrode stack(s) are electrodes coated with an anion exchange coating.

7. The system of claim 6, wherein cation exchange membranes are adjacent to said electrodes coated with an anion exchange coating.

8. The system of claim 3, wherein both of the two electrodes of at least one of the electrode stack(s) are electrodes coated with a cation exchange coating.

9. The system of claim 8, wherein anion exchange membranes are adjacent to said electrodes coated with a cation exchange coating.

10. The system of claim 1, wherein said ion exchange coating is coated on the surface of an electrode matrix of said electrode coated with an ion exchange coating.

11. The system of claim 1, wherein an electrode matrix of said electrode coated with an ion exchange coating comprises a porous material.

12. The system of claim 11, wherein said ion exchange coating is coated inside porous portions of the porous material.

13. The system of claim 11, wherein said ion exchange coating is coated inside porous portions of the porous material and on the surface of the electrode matrix.

14. The system of claim 11, wherein said porous material is selected from the group consisting of activated carbon, carbon nanotubes, graphite, carbon fiber, carbon cloth, carbon aerogel, metallic powders, metal oxides, conductive polymers, and any combinations thereof.
